(19) United States
(12) Patent Application Publication
(10) Pub. No.: US 2014/0001848 A1
(43) Pub. Date: Jan. 2, 2014

(54) CHARGING-RATE EQUALIZING APPARATUS AND BATTERY SYSTEM

(71) Applicant: MITSUBISHI HEAVY INDUSTRIES, LTD., Tokyo (JP)

(72) Inventor: Hideki Hashimoto, Tokyo (JP)

(21) Appl. No.: 13/929,468

(22) Filed: Jun. 27, 2013

(30) Foreign Application Priority Data
Jul. 2, 2012 (JP) 2012-148696

(51) Int. Cl. H02J 7/00

(52) U.S. Cl. CPC H02J 7/0013
USPC 307/18

(57) ABSTRACT

A battery system is equipped with a plurality of batteries to which first loads are connected individually and which are connected in series. In the battery system, a second load is connected in series to the plurality of batteries. A BSC provided in the battery system determines a battery whose SOC has become lower than the SOCs of the other batteries by a saving-needed value or more and restricts driving of the first load connected to the battery whose SOC is determined to be lower by a saving-needed value or more. This can suppress power consumption and an increase in the cost of the battery system and can equalize the charging rates of the plurality of batteries.

### TECHNICAL FIELD

The present invention relates to a charging-rate equalizing apparatus and a battery system.

### BACKGROUND ART

A battery system equipped with a plurality of batteries requires equalizing the charging rates of the individual batteries to, for example, make the lives of the batteries uniform and stabilize the discharge voltage.

PTL 1 discloses a battery pack unit in which resistors are connected in parallel, via transistors, to individual module batteries that constitute a battery pack, and the transistors of module batteries with high voltages are turned on so that the remaining capacities of the individual module batteries become equal, thereby causing the electric power to be consumed by the resistors.

### CITATION LIST

### Patent Literature

{PTL 1} Japanese Unexamined Patent Application, Publication No. 2006-101699

### SUMMARY OF INVENTION

### Technical Problem

However, the battery pack unit disclosed in PTL 1 causes the electric power to be consumed by the resistors only for equalizing the charging rates, which therefore results in wasteful power consumption when equalizing the charging rates and an increase in cost due to providing the resistors.

The present invention is made in consideration of such circumstances, and an object thereof is to provide a charging-rate equalizing apparatus and a battery system in which power consumption and an increase in cost can be suppressed, and in which the charging rates of a plurality of batteries can be equalized.

### Solution to Problem

To solve the above problems, a charging-rate equalizing apparatus and a battery system of the present invention adopt the following solutions.

Specifically, a charging-rate equalizing apparatus according to a first aspect of the present invention is a charging-rate equalizing apparatus that equalizes the charging rates of a plurality of batteries which are connected in series or in parallel and to which first loads that are driven when supplied with electric power are connected individually, the apparatus comprising: a control unit for determining the battery whose charging rate is lower than the charging rates of the other batteries by a predetermined value or more and for restricting driving of the first load connected to the battery whose charging rate is determined to be lower by the predetermined value or more.

With this configuration, first loads are connected individually to the plurality of batteries, and the batteries are connected in series or in parallel. The batteries may be either battery packs or cells.

A battery whose charging rate, calculated for each of the plurality of batteries, has become lower than the charging rates of the other batteries by a predetermined value or more is determined, and driving of the first load connected to the battery whose charging rate is determined to be lower by the predetermined value or more is restricted by the control unit.

This suppresses the power consumption of the first load connected to the battery whose charging rate has become lower than those of the other batteries as compared with the first loads connected to the other batteries, so that the difference in charging rate from the other batteries is decreased with time, and thus the charging rates are equalized.

Thus, this configuration prevents wasteful power consumption and eliminates the need for resistors for merely equalizing the charging rates of the plurality of batteries, thus allowing power consumption and an increase in cost to be suppressed and the charging rates of the plurality of batteries to be equalized.

In the above first aspect, preferably, the control unit stops driving of the first load connected to the battery whose charging rate has become less than a predetermined lower limit value.

With this configuration, driving of the first load connected to the battery whose charging rate has become less than the predetermined lower limit value is stopped, and thus, an excessive decrease in the charging rates of the batteries is suppressed.

In the above first aspect, preferably, the control unit stops driving of the first load connected to the battery whose charging rate has become less than a predetermined first lower limit value and restricts driving of the first load connected to the battery whose charging rate has become greater than or equal to the first lower limit value and less than a predetermined second lower limit value.

With this configuration, since the first load connected to the battery whose charging rate has become less than the second lower limit value is subjected to driving restriction even if the charging rate is greater than or equal to the first lower limit value, the decrease in the charging rate of the battery in which driving of the first load is restricted becomes more gentle, thereby more assuredly preventing an excessive decrease in the charging rate of the battery.

In the above first aspect, preferably, a plurality of the first loads are connected in parallel to at least one battery of the plurality of the batteries, and in the case where the control unit determines that the charging rate of the battery to which the plurality of first loads are connected is lower than the charging rates of the other batteries by a predetermined value or more, the control unit restricts driving of the plurality of first loads connected to the battery in a predetermined order of ascending priority.

With this configuration, the plurality of first loads are connected in parallel to the battery, and driving of the plurality of first loads connected to the battery is restricted in a predetermined order of ascending priority, thus allowing selection of a first load whose driving is to be restricted, for example, setting a high order of priority for a first load for ensuring the safety of an electric vehicle.

The first loads connected to the battery may include various kinds of load.

In the above first aspect, preferably, in the case where the charging rates of all the batteries are greater than or equal to a predetermined given value, the control unit does not restrict driving of the first loads.

With this configuration, since driving of the first loads is not restricted at high charging rates, the ability to use the first loads is increased, which can suppress the need to maintain the charging rate of the battery high.

In the above first aspect, preferably, at least one second load is connected to the plurality of batteries connected in series or in parallel.

With this configuration, at least one second load is connected to the plurality of batteries. Since the charging rates of the plurality of batteries connected to the second load are equalized, the second load that is supplied with electric power from the plurality of batteries at the same time can be stably driven.

In the above first aspect, preferably, the first loads include an air conditioning device.

With this configuration, since the first load is an air conditioning device (for example, a heater or a cooler), the amount of electric power consumed by the first load can easily be limited by limiting the value of current flowing in the air conditioning device, and thus, driving restriction by the control unit can easily be achieved.

A battery system according to a second aspect of the present invention includes a plurality of batteries connected in series or in parallel; first loads connected in parallel to the batteries and driven when supplied with electric power from the connected batteries; and a control unit for determining the battery whose charging rate has become lower than the charging rates of the other batteries by a predetermined value or more and for restricting driving of the first load connected to the battery whose charging rate is determined to be lower by the predetermined value or more.

### Advantageous Effects of Invention

The present invention has an advantageous effect of suppressing power consumption and an increase in cost and equalizing the charging rates of a plurality of batteries.

### BRIEF DESCRIPTION OF DRAWINGS

FIG. 1 is a diagram showing the configuration of a battery system according to a first embodiment of the present invention.

FIG. 2 is a functional block diagram showing the configurations of BMUs, a BSC, and a heater controller according to the first embodiment of the present invention.

FIG. 3 is a flowchart showing the flow of a charging-rate equalizing process according to the first embodiment of the present invention.

FIG. 4 is a flowchart showing the flow of a charging-rate equalizing process according to a second embodiment of the present invention.

FIG. 5 is a flowchart showing the flow of a charging-rate equalizing process according to a third embodiment of the present invention.

### DESCRIPTION OF EMBODIMENTS

Embodiments of a charging-rate equalizing apparatus and a battery system according to the present invention will be described hereinbelow with reference to the drawings.

### First Embodiment

A first embodiment of the present invention will be described hereinbelow.

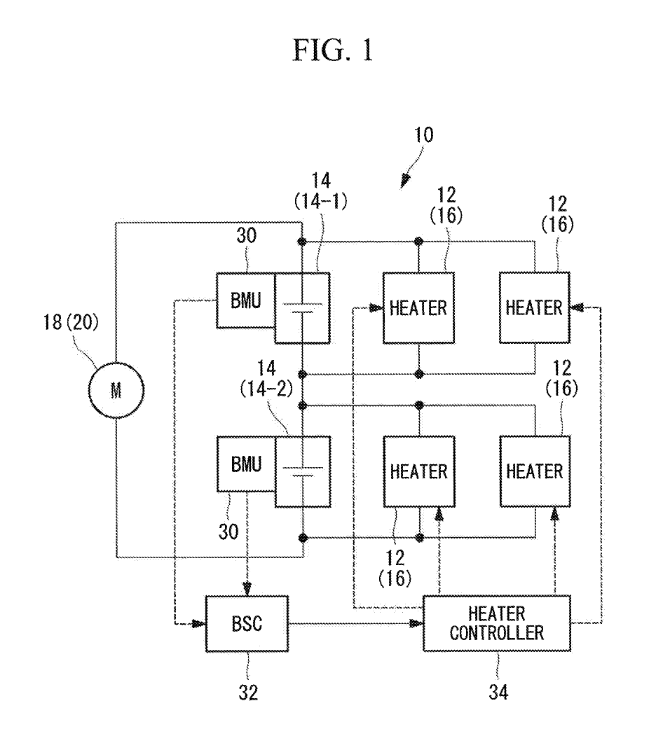

FIG. 1 is a diagram showing the configuration of a battery system 10 according to the first embodiment. The battery system 10 will be described as applied to a case in which it is provided in, for example, an electric vehicle, by way of example.

The battery system 10 is equipped with a plurality of batteries 14 (a battery 14-1 and a battery 14-2), a plurality of first loads 12 connected in parallel to the individual batteries 14, and a second load 18 connected to the battery group composed of the plurality of batteries 14. A single battery 14 may be either a cell or a module battery in which a plurality of cells are connected in series or in parallel. Although the cells that constitute the batteries 14 are secondary batteries, for example, lithium-ion secondary batteries, the present invention is not limited thereto; they may be various types of secondary battery, such as lead-acid batteries, or primary batteries.

The first loads 12 are electric devices that are driven when receiving electric power, for example, heaters 16. Examples of the heaters include window heaters provided on the windows of the electric vehicle, seat heaters provided in the seats, and hot-air heaters serving as air-conditioning devices. Various kinds of load, such as an audio system, a car navigation system, an interior light, and an air conditioner, may be connected to the batteries 14 as the first loads 12.

The second load 18 is connected in series to the plurality of batteries 14 and is driven by electric power supplied from the plurality of batteries 14. An example of the second load 18 is a motor 20 for rotating the driving wheels of the electric vehicle.

The connecting method and the numbers of batteries 14, first loads 12, and second load 18 shown in FIG. 1 are merely an example; three or more batteries 14 may be connected in series or in parallel, at least one or more first loads 12 may be connected in parallel to each of the batteries 14, and a plurality of second loads 18 may be connected to the battery group composed of the plurality of batteries 14. In the case where the batteries 14 are connected in parallel, it is desirable to connect conductors in parallel to the individual batteries 14 so as to rectify any unbalance between the voltages and currents of the individual batteries.

The battery system 10 is equipped with battery management units (BMUs) 30, a battery system controller (BSC) 32, and a heater controller 34. A BMU 30 is provided in each battery 14.

The BMUs 30, the BSC 32, and the heater controller 34 are constituted by, for example, a central processing unit (CPU), a random access memory (RAM), and a computer-readable recording medium. A series of processes for achieving the various functions of the BMUs 30, the BSC 32, and the heater controller 34, as one example, are recorded in the recording medium or the like in the form of a program, and the various functions are realized by the CPU reading the program into the RAM or the like and executing information processing and computational processing.

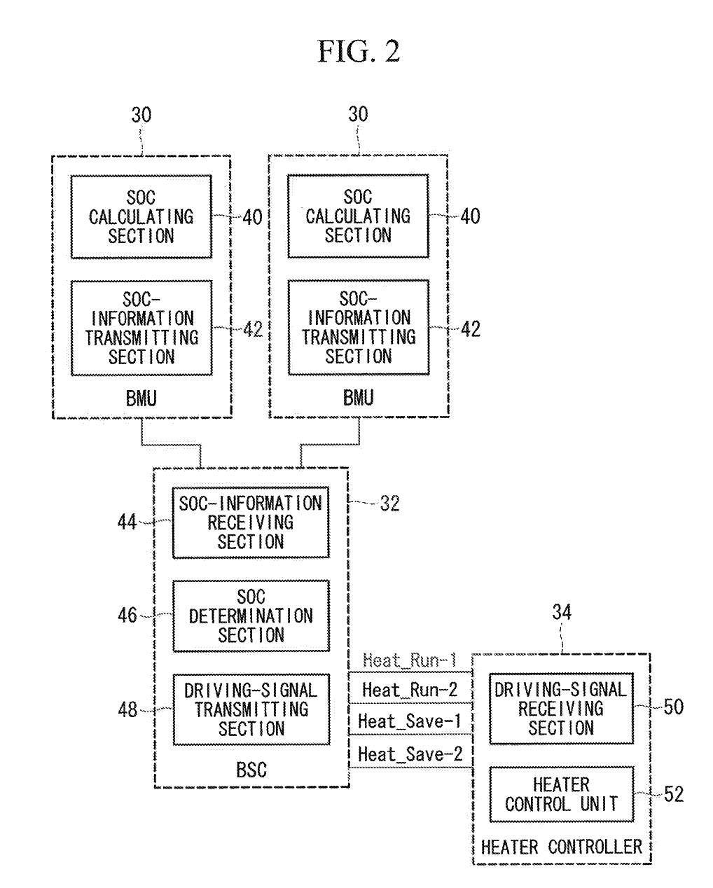

FIG. 2 is a functional block diagram showing the configurations of the BMUs 30, the BSC 32, and the heater controller 34 according to the first embodiment.

The BMUs 30 are units that manage the plurality of batteries 14-1 and 14-2 and transmit and receive various signals to and from the BSC 32 serving as a higher-level control unit and are equipped with SOC calculating sections 40 and SOC-information transmitting sections 42.

The SOC calculating sections 40 calculate the charging rates (states of charge, hereinafter referred to as “SOCs”) of the individual batteries 14 to which the BMUs 30 correspond individually. The SOCs may be calculated using a known calculation method; for example, they are calculated by integrating the currents by using information on the current values of the batteries 14.

The SOC-information transmitting sections 42 transmit the SOCs calculated by the SOC calculating sections 40 to the BSC 32 as SOC information.

The BMUs 30 repeat the calculation of the SOCs and the transmission of the SOC information at predetermined timing. The predetermined timing is, for example, a timing corresponding to when the electric vehicle starts driving (for example, ignition-switch ON timing) and a timing corresponding to a fixed time after starting to drive (for example, a timing of every five minutes).

The BSC 32 is a control unit for controlling and managing the first loads 12 (heaters 16) mounted in the electric vehicle and for performing various controls such as receiving SOC information from the BMUs 30 and transmitting driving signals for controlling driving of the first loads 12 to the heater controller 34 depending on the SOCs. The BSC 32 is equipped with an SOC-information receiving section 44, an SOC determination section 46, and a driving-signal transmitting section 48.

The SOC-information receiving section 44 receives the SOC information of the individual batteries 14 transmitted from the SOC-information transmitting sections 42 of the individual BMUs 30.

The SOC determination section 46 determines whether a battery 14 whose SOC has become lower than the SOCs of the other batteries 14 by a predetermined value or more exists on the basis of the SOC information that the SOC-information receiving section 44 has received. The detailed determination method in the SOC determination section 46 will be described later.

The driving-signal transmitting section 48 generates driving signals for the first loads 12 (in this embodiment, the heaters 16) on the basis of the result determined by the SOC determination section 46 and transmits them to the heater controller 34.

The driving signals include a driving allow/disallow signal indicating whether driving of the heater 16 is allowed and a capacity saving signal for restricting driving of the heater 16 on the basis of the result of determination by the SOC determination section 46. When the heater 16 is to be driven without restriction, the capacity saving signal is not transmitted to the heater controller 34. A plurality of capacity saving signals may be prepared depending on the degree of restriction. For example, assuming that the unrestricted driving state of the heater 16 is 100%, three capacity saving signals, that is, a capacity saving signal for setting the driving state of the heater 16 to 80%, a capacity saving signal for 40%, and a capacity saving signal for 20%, are prepared as capacity saving signals.

In the first embodiment described below, a driving allow/disallow signal for the heater 16 connected to the battery 14-1 is referred to as “Heat_Run-1”, and a driving allow/disallow signal for the heater 16 connected to the battery 14-2 is referred to as “Heat_Run-2”. A capacity saving signal for the heater 16 connected to the battery 14-1 is referred to as “Heat_Save-1”, and a capacity saving signal for the heater 16 connected to the battery 14-2 is referred to as “Heat_Save-2”.

The heater controller 34 is a device that receives the individual signals from the BSC 32 and that controls driving of the individual heaters 16 and is equipped with a driving-signal receiving section 50 and a heater control unit 52.

The driving-signal receiving section 50 receives the driving signals transmitted from the driving-signal transmitting section 48 of the BSC 32.

The heater control unit 52 controls the individual heaters 16 on the basis of the driving signals received by the driving-signal receiving section 50.

Specifically, in the case where the driving-signal receiving section 50 has received only a driving allow/disallow signal for allowing driving of the heater 16, the heater control unit 52 lets a current of a predetermined value flow to the heater 16. On the other hand, in the case where the driving-signal receiving section 50 has received a capacity saving signal together with a driving allow/disallow signal for allowing driving of the heater 16, the heater control unit 52 lets a current according to the degree of restriction, indicated by the capacity saving signal, relative to a predetermined value flow to the heater 16.

In the battery system 10 according to the first embodiment, the BSC 32 functions as a charging-rate equalizing apparatus and performs a charging-rate equalizing process for restricting driving of a heater 16 connected to a battery 14 whose SOC has become lower than the SOCs of the other batteries 14 by a predetermined value or more.

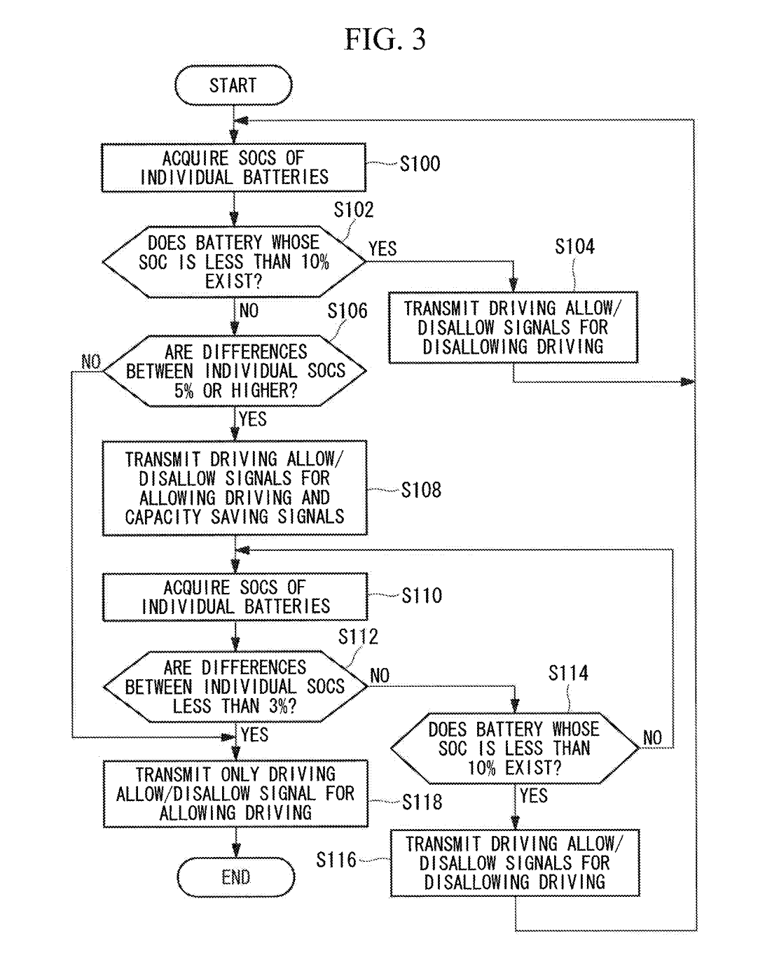

FIG. 3 is a flowchart showing the flow of the charging-rate equalizing process performed by the BSC 32 according to the first embodiment. The charging-rate equalizing process is performed, for example, when it is instructed to drive the heater 16, which is the first load 12, by a switching operation or the like; at the start of the charging-rate equalizing process, the heater 16 is not in operation. The individual processes shown in the flowchart of FIG. 3 may be freely performed in a different order or in parallel so long as no conflict arises in the processing details.

First, in step 100, the SOC-information receiving section 44 acquires the SOCs of the individual batteries 14 by receiving SOC information from the BMUs 30 corresponding to the individual batteries 14. The individual BMUs 30 calculate the SOCs of the corresponding batteries 14 at a predetermined timing, for example, immediately after the power of the electric vehicle in which the battery system 10 is installed is turned on, and transmit the SOC information to the BSC 32.

In the next step 102, the SOC determination section 46 determines whether a battery 14 whose SOC has become less than a driving stop value exists; if a battery 14 whose SOC has become less than the driving stop value exists, the process goes to step 104, and if a battery 14 whose SOC has become less than the driving stop value does not exist, the process goes to step 106. The driving stop value is a predetermined lower limit value for preventing over discharge of the batteries 14. In the first embodiment, the driving stop value is set to 10% as an example (SOC at full charge is 100%).

In step 104, the driving-signal transmitting section 48 transmits driving allow/disallow signals for disallowing driving of the individual heaters 16 to the heater controller 34, and the process returns to step 100. For example, if the SOC of the battery 14-1 and 14-2 is less than 10%, the driving-signal transmitting section 48 transmits to the heater controller 34 the driving allow/disallow signal “heat_run-1” for disallowing driving of the heater 16 connected to the battery 14-1 and the driving allow/disallow signal “heat_run-2” for disallowing driving of the heater 16 connected to the battery 14-2.

Since this prevents the heaters 16 from starting driving, an excessive decrease in the SOCs of the batteries 14 is suppressed. In this case, the BSC 32 may send a signal to a display panel placed, for example, on the front panel of the electric vehicle equipped with the battery system 10, and may display an instruction for the driver to charge the battery 14 on the display panel.

In the case where the plurality of batteries 14 are controlled so that they are equally charged and discharged, when the SOC of at least one battery 14 of the plurality of batteries 14 has become less than the driving stop value, the SOCs of the other batteries 14 may also be in the vicinity of the driving stop value, and thus, it is desirable to control all the heaters 16 so that the driving is disallowed. Alternatively, the driving-signal transmitting section 48 may transmit a driving allow/disallow signal for disallowing driving of a heater 16 connected to the battery 14 whose SOC is determined to be less than the driving stop value, may transmit a driving allow/disallow signal for allowing driving of heaters 16 connected to batteries 14 whose SOCs are determined to be greater than or equal to the driving stop value, so that only the heater 16 connected to the battery 14 whose SOC is determined to be greater than the driving stop value is driven.

In step 106, the SOC determination section 46 determines whether the SOC of one battery 14 of the plurality of batteries 14 is lower than the SOCs of the other batteries 14 by a predetermined value or more (a saving-needed value or more); in other words, it compares the SOCs of the plurality of batteries 14 to determine whether the differences between them are larger than or equal to the predetermined value. Specifically, the SOC determination section 46 determines whether the difference between the SOC of the battery 14-1 and the SOC of the battery 14-2 is larger than or equal to the saving-needed value; if a positive determination is made, the process goes to step 108, and if a negative determination is made, the process goes to step 118. In the first embodiment, the saving-needed value is set to 5%, as an example.

In step 108, the driving-signal transmitting section 48 transmits driving allow/disallow signals for allowing driving of the individual heaters 16 to the heater controller 34 and transmits a capacity saving signal for restricting driving of a heater 16 connected to a battery 14 whose SOC is determined to be lower by the saving-needed value or more to the heater controller 34. For example, if the SOC of the battery 14-1 is 40%, and the SOC of the battery 14-2 is 46%, the difference therebetween is 6%, so that the SOC of the battery 14-1 is lower than the SOC of the battery 14-2 by the saving-needed value (5%) or more. Accordingly, the driving-signal transmitting section 48 transmits the driving allow/disallow signal “heat_run-1” for allowing driving of the heater 16 connected to the battery 14-1 and the capacity saving signal “heat-save-1” for restricting the driving to the heater controller 34 and transmits the driving allow/disallow signal “heat_run-2” for allowing driving of the heater 16 connected to the battery 14-2 to the heater controller 34. The capacity saving signal may include different capacity saving signals depending on deviations from the saving-needed value. For example, if the difference between the two compared batteries 14 is 5 to 10%, the driving-signal transmitting section 48 transmits to the heater controller 34 a capacity saving signal that brings the driving state of the heater 16 to 80%, if the above difference is 10 to 15%, transmits a capacity saving signal that brings the driving state of the heater 16 to 40%, and if the above difference is 15% or larger, transmits a capacity saving signal that brings the driving state of the heater 16 to 20%.

This allows the heaters 16 connected to the individual batteries 14 to start driving but restricts driving of the heaters 16 whose driving is to be restricted depending on the degree of restriction indicated by the capacity saving signals, thus suppressing the power consumption. Therefore, the power consumption of the heaters 16 connected to the batteries 14 whose SOCs have become lower than those of the other batteries 14 is suppressed as compared with the heaters 16 connected to the other batteries 14, so that the difference in SOC from the other batteries 14 is decreased with time, and thus the SOCs are equalized.

In the next step 110, the SOC-information receiving section 44 receives SOC information from the BMUs 30 corresponding to the individual batteries 14 after the lapse of a predetermined time to obtain the SOCs of the individual batteries 14.

In the next step 112, the SOC determination section 46 determines whether the differences between the SOCs of the plurality of batteries 14 are less than a restriction canceling value for canceling the driving restriction; if a positive determination is made, the process goes to step 118, and if a negative determination is made, the process goes to step 114. In the first embodiment, the restriction canceling value is set to 3% as an example.

In step 114, the SOC determination section 46 determines whether a battery 14 whose SOC has become less than the driving stop value exists; if a battery 14 whose SOC has become less than the driving stop value exists, the process goes to step 116, and if a battery 14 whose SOC has become less than the driving stop value does not exist, the process returns to step 110.

In step 116, the driving-signal transmitting section 48 transmits driving allow/disallow signals for disallowing driving of the individual heaters 16 to the heater controller 34, as in step 104, and the process returns to step 100.

In step 118 that the process goes to when a negative determination is made in step 106 or a positive determination is made in step 112, the driving-signal transmitting section 48 transmits only driving allow/disallow signals for allowing driving of the individual heaters 16 to the heater controller 34.

In other words, in the case where the process goes from step 106 to step 118, the differences between the SOCs of the plurality of batteries 14 are less than the saving-needed value at which driving restriction is necessary, and thus, the driving-signal transmitting section 48 transmits only the driving allow/disallow signals for allowing driving of the individual heaters 16 to the heater controller 34 without transmitting a capacity saving signal.

On the other hand, in the case where the process goes from step 112 to step 118, the driving-signal transmitting section 48 stops the transmission of the capacity saving signal that has been transmitted until then and transmits only the driving allow/disallow signals for allowing driving of the heaters 16 to the heater controller 34. Thus, the heater controller 34 cancels the driving restriction of the controlled heaters 16 to drive the heaters 16.

Although the BSC 32 according to the first embodiment terminates the charging-rate equalizing process when terminating the process in step 118, the present invention is not limited thereto; the charging-rate equalizing process may be repeated until the instruction to drive the heaters 16 is stopped.

The BSC 32 may restrict driving of the plurality of first loads 12 connected to the individual batteries 14 in a predetermined order of ascending priority.

For example, in the case where a window heater, an audio system, a car navigation system, a seat heater, a hot-air heater, a cabin light, and an air conditioning device are connected to the batteries 14 as the first loads 12, the order of priority can be determined in consideration of, for example, the safety of the electric vehicle. For example, since the window heater is used to defog the windows of the electric vehicle and has a large influence on the safety of the electric vehicle, the highest priority is given thereto, and since the audio system is necessary for the driver etc. to collect information in case of emergency, the next highest priority is given thereto.

As an example, a case where individual heaters, such as a window heater, a hot-air heater, and a seat heater, are connected to the individual batteries 14 as the first loads 12, and the priority of the need for driving is assigned to the window heater, the hot-air heater, and the seat heater in this order will be described. In this case, for example, if the SOC of the battery 14-1 is 40%, and the SOC of the battery 14-2 is 46%, the difference therebetween is 6%, so that the SOC of the battery 14-1 is lower than the SOC of the battery 14-2 by the saving-needed value (5%) or more. Accordingly, the driving-signal transmitting section 48 transmits to the heater controller 34 driving allow/disallow signals for allowing driving of the individual heaters connected to the battery 14-1 and capacity saving signals for restricting driving of the hot-air heater and the seat heater connected to the battery 14-1 and transmits driving allow/disallow signals for allowing driving of the individual heaters connected to the battery 14-2 to the heater controller 34.

In addition, a plurality of capacity saving signals determined in accordance with the order of priority of restricting driving of the first loads 12 may also be prepared depending on deviations from the saving-needed value. For example, if the difference between the two compared batteries 14 is 5 to 10%, the driving-signal transmitting section 48 can transmit a capacity saving signal for restricting driving of only the seat heater to the heater controller 34, and if the above difference is 10 to 15%, can transmit a capacity saving signal for restricting driving of both the hot-air heater and the seat heater to the heater controller 34, and if the above difference is 15% or larger, can transmit a capacity saving signal for restricting driving of all of the window heater, the hot-air heater, and the seat heater to the heater controller 34.

By determining the order of priority of restricting driving of the plurality of first loads 12 in advance in this way, the BSC 32 can select a first load 12 whose driving is to be restricted.

As described above, the battery system 10 according to the first embodiment determines a battery 14 whose SOC has become lower than the SOCs of the other batteries 14 by the saving-needed value or more and restricts driving of the first load 12 connected to the battery 14 whose SOC is determined to be lower by the saving-needed value or more. This prevents the battery system 10 from wastefully consuming electric power and eliminates the need for resistors for merely equalizing the SOCs of the plurality of batteries 14, thus allowing power consumption and an increase in cost to be suppressed and the charging rates of the plurality of batteries 14 to be equalized.

Furthermore, in the battery system 10 according to the first embodiment, the motor 20 serving as at least one second load 18 is connected in series to the plurality of batteries 14.

Since the battery system 10 equalizes the SOCs of the plurality of batteries 14 connected to the second load 18, the second load 18 that is supplied with electric power from the plurality of batteries 14 at the same time can be stably driven.

Furthermore, in the battery system 10 according to the first embodiment, since the first load 12 is the heater 16, the amount of electric power consumed by the heater 16 can easily be limited by limiting the value of current flowing in the heater 16, and thus, driving restriction of the first load 12 can easily be achieved.

### Second Embodiment

A second embodiment of the present invention will be described hereinbelow.

Since the configuration of a battery system 10 according to the second embodiment is the same as the configuration of the battery system 10 according to the first embodiment shown in FIGS. 1 and 2, a description thereof will be omitted.

The battery system 10 according to the second embodiment stops driving of a first load 12 connected to the battery 14 whose SOC has become less than a predetermined driving stop value (first lower limit value) and restricts driving of a first load 12 connected to a battery 14 whose SOC has become greater than or equal to the driving stop value and less than a predetermined drive restricting value (second lower limit value).

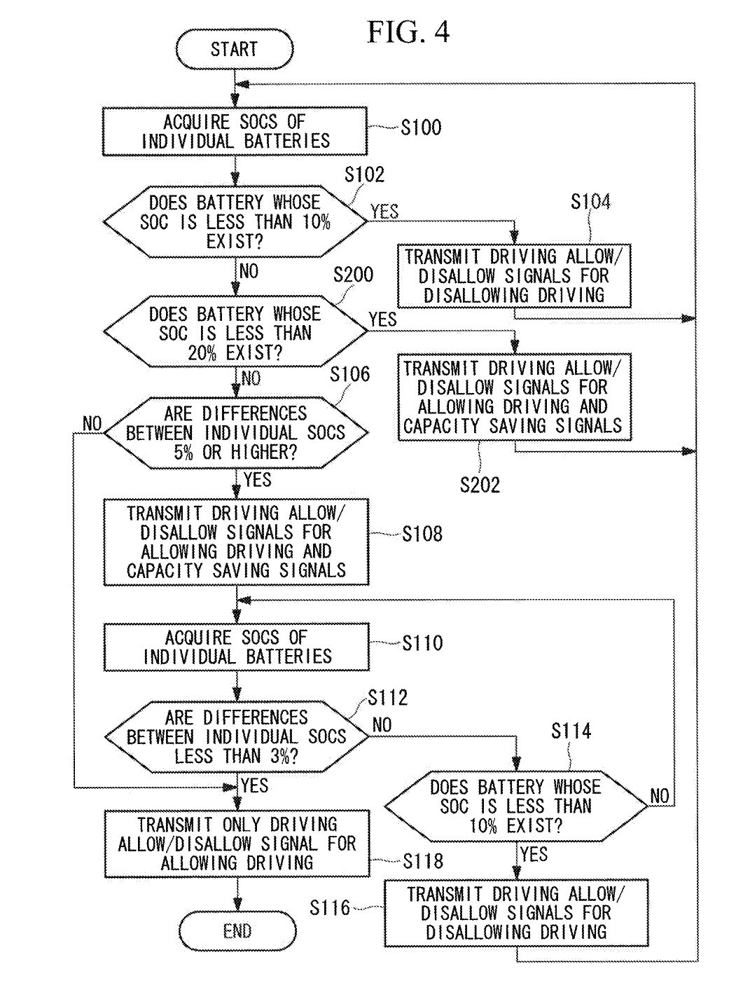

FIG. 4 is a flowchart showing the flow of a charging-rate equalizing process according to the second embodiment. The same steps in FIG. 4 as those in FIG. 3 are given the same reference signs as in FIG. 3, and part or all of the descriptions thereof will be omitted.

If a negative determination is made in the process of step 102, the process goes to step 200.

In step 200, the SOC determination section 46 determines whether a battery 14 whose SOC has become less than the drive restricting value exists; if a battery 14 whose SOC has become less than the drive restricting value exists, the process goes to step 202, and if a battery 14 whose SOC has become less than the drive restricting value does not exist, the process goes to step 106. The drive restricting value is a lower limit value for preventing over discharge of the battery 14 more assuredly. In the second embodiment, the drive restricting value is set to 20%, as an example.

In step 202, the driving-signal transmitting section 48 transmits driving allow/disallow signals for allowing driving of the individual heaters 16 to the heater controller 34 and transmits to the heater controller 34 capacity saving signals for restricting driving of heaters 16 connected to the batteries 14 whose SOCs are determined to be less than the drive restricting value. As in the case of the first embodiment, a plurality of capacity saving signals according to the degrees of restriction may be prepared, and the degrees of restriction indicated by the capacity saving signals are set higher as deviations from the drive restricting value increase.

As described above, in the battery system 10 according to the second embodiment, the first load 12 connected to the battery 14 whose SOC has become less than the drive restricting value is subjected to driving restriction even if the SOC is greater than or equal to the driving stop value, and thus, the decrease in the SOC of the battery 14 in which driving of the first load 12 is restricted becomes more gentle, thereby preventing an excessive decrease in the SOC and over discharge of the battery 14 with increased certainty.

### Third Embodiment

A third embodiment of the present invention will be described hereinbelow.

Since the configuration of a battery system 10 according to the third embodiment is the same as the configuration of the battery system 10 according to the first embodiment shown in FIGS. 1 and 2, a description thereof will be omitted.

In the case where the SOCs of all the batteries 14 are greater than or equal to a predetermined given value (upper restrict value), the battery system 10 according to the third embodiment does not restrict driving of the first loads 12.

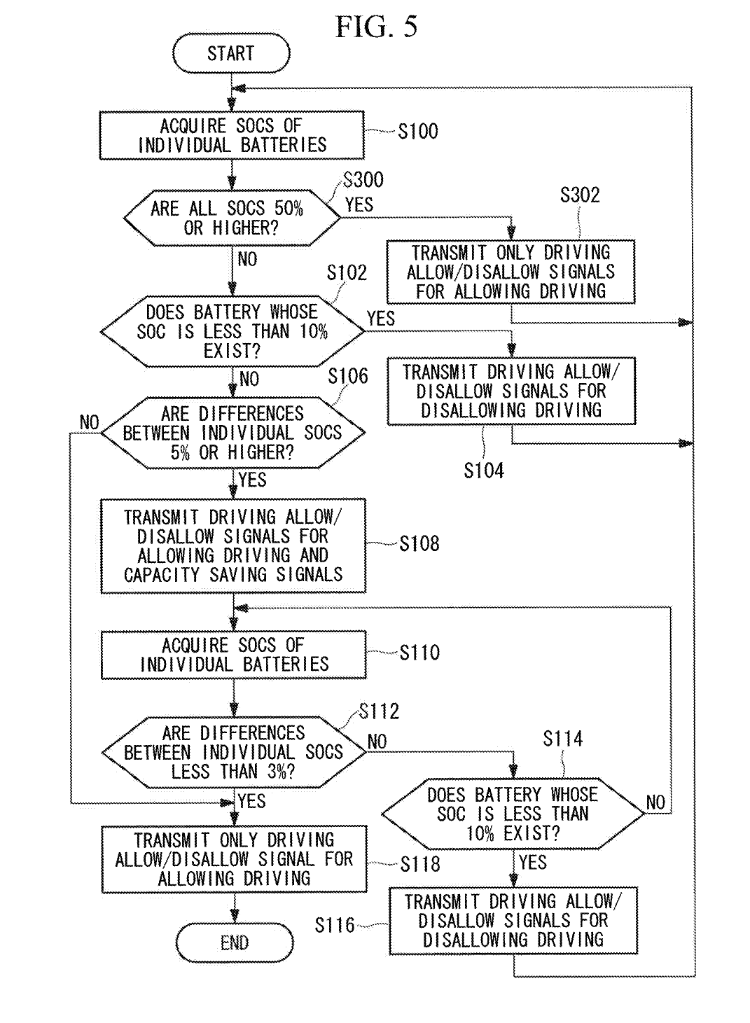

FIG. 5 is a flowchart showing the flow of a charging-rate equalizing process according to the third embodiment. The same steps in FIG. 5 as those in FIG. 3 are given the same reference signs as in FIG. 3, and part or all of descriptions thereof will be omitted.

After the process in step 100 ends, the process goes to step 300.

In step 300, the SOC determination section 46 determines whether the SOCs of all the batteries 14 are greater than or equal to the predetermined upper limit value; if a positive determination is made, the process goes to step 302, and if a negative determination is made, the process goes to step 102.

The above upper limit value is a threshold value that eliminates the need for determining whether the differences between the SOCs of the individual batteries 14 are greater than or equal to a saving-needed value, and in the third embodiment, it is set to 50% as an example.

In step 302, the driving-signal transmitting section 48 transmits only driving allow/disallow signals for allowing driving of the heaters 16 connected to the individual batteries 14 to the heater controller 34 without transmitting a capacity saving signal, and the process returns to step 100.

As described above, with the battery system 10 according to the third embodiment, since driving of the first loads 12 is not restricted at high SOCs, the ability to use the first loads 12 is increased.

Furthermore, when the battery 14 undergoes repeated charging and discharging at a high SOC (for example, 60 to 70%), degradation of the active material, the separator, the electrolyte, and so on that constitute the battery 14 is accelerated as compared with a case where charging and discharging are repeated at a low SOC (for example, 30 to 40%). Therefore, by not restricting driving of the first load 12 at a high SOC, consumption of charged power is accelerated, which can suppress the need to maintain the SOC of the battery 14 high, thus resulting in an extended life of the battery 14.

Although the present invention has been described using the above embodiments, the technical scope of the present invention is not limited to the scope of the above embodiments. Various changes or modifications can be made to the above embodiments without departing from the scope of the present invention, and the changes or modifications are also included in the technical scope of the present invention.

For example, the above embodiments have been described as applied to a configuration in which the battery system 10 is equipped with the two batteries 14-1 and 14-2; however, the present invention is not limited thereto and may have a configuration in which the battery system 10 is equipped with three or more batteries 14. With this configuration, for example, a first load 12 connected to a battery 14 in which the difference from the highest SOC has decreased by a predetermined value or more is subjected to driving restriction.

Furthermore, the above embodiments have been described as applied to a configuration in which a first load 12 connected to a battery 14 in which the difference from the SOCs of the other batteries 14 has decreased by a predetermined value or more is subjected to driving restriction; however, the present invention is not limited thereto and may have a configuration in which a first load 12 connected to a battery 14 in which the deviation of the SOC from the mean value of the SOCs has decreased by a predetermined value or more is subjected to driving restriction and a configuration in which a first load 12 connected to a battery 14 with a low SOC, where the ratio to the SOCs of the other batteries 14 is at a predetermined value or more, is subjected to driving restriction.

Furthermore, the above embodiments have been described as applied to a configuration in which the plurality of batteries 14 are connected in series; however, the present invention is not limited thereto and may have a configuration in which the plurality of batteries 14 are connected in parallel.

### REFERENCE SIGNS LIST

10 battery system
12 first load
14 battery
16 heater
18 second load
30 BMU
32 BSC
34 heater controller

1. A charging-rate equalizing apparatus that equalizes the charging rates of a plurality of batteries which are connected in series or in parallel and to which first loads that are driven when supplied with electric power are connected individually, the apparatus comprising:
a control unit for determining the battery whose charging rate has become lower than the charging rates of the other batteries by a predetermined value or more and for restricting driving of the first load connected to the battery whose charging rate is determined to be lower by the predetermined value or more.

2. The charging-rate equalizing apparatus according to claim 1, wherein the control unit stops driving of the first load connected to the battery whose charging rate has become less than a predetermined lower limit value.

3. The charging-rate equalizing apparatus according to claim 1, wherein the control unit stops driving of the first load connected to the battery whose charging rate has become less than a predetermined first lower limit value and restricts driving of the first load connected to the battery whose charging rate has become greater than or equal to the first lower limit value and less than a predetermined second lower limit value.

4. The charging-rate equalizing apparatus according to claim 1, wherein
a plurality of the first loads are connected in parallel to at least one battery of the plurality of the batteries; and
in the case where the control unit determines that the charging rate of the battery to which the plurality of first loads are connected is lower than the charging rates of the other batteries by a predetermined value or more, the control unit restricts driving of the plurality of first loads connected to the battery in a predetermined order of ascending priority.

5. The charging-rate equalizing apparatus according to claim 1, wherein in the case where the charging rates of all the batteries are greater than or equal to a predetermined given value, the control unit does not restrict driving of the first loads.

6. The charging-rate equalizing apparatus according to claim 1, wherein at least one second load is connected to the plurality of batteries connected in series or in parallel.

7. The charging-rate equalizing apparatus according to claim 1, wherein the first loads include an air conditioning device.

8. A battery system comprising:
a plurality of batteries connected in series or in parallel;
first loads connected in parallel to the batteries and driven when supplied with electric power from the connected batteries; and
a control unit for determining the battery whose charging rate has become lower than the charging rates of the other batteries by a predetermined value or more and for restricting driving of the first load connected to the battery whose charging rate is determined to be lower by the predetermined value or more.
